(19) United States
(12) Patent Application Publication
(10) Pub. No.: US 2013/0208762 A1
(43) Pub. Date: Aug. 15, 2013

(54) Suppression of Stimulated Raman Scattering

(71) Applicants: Ian Bradford Mitchell, Austin, TX (US); Mikko Jaaskelamen, Katy, TX (US)

(72) Inventors: Ian Bradford Mitchell, Austin, TX (US); Mikko Jaaskelamen, Katy, TX (US)

(73) Assignee: Halliburton Energy Services Inc.

(21) Appl. No.: 13/396,416

(22) Filed: Feb. 14, 2012

(51) Int. Cl. G01K 11/32

(52) U.S. Cl. 374/161; 374/E11.015

(57) ABSTRACT

An apparatus and method for suppressing stimulated Raman scattering (SRS) in fiber optic distributed temperature sensing systems by use of a combination of a pump and seed lasers with chosen frequency differences.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

This disclosure relates generally to fiber optic distributed temperature sensing (DTS) systems and, more particularly, to methods and systems for extending the range of fiber optic DTS systems by means of suppression of stimulated Raman scattering

### BACKGROUND OF THE INVENTION

This disclosure relates generally to distributed temperature sensing (DTS) systems and, more particularly, to methods and systems for extending the range of fiber optic DTS systems.

For several years, fiber optic sensors, and in particular DTS systems, have provided higher bandwidth, inherently safe operation (no generation of electric sparks), and immunity from EMI (Electromagnetic Interference) for parameter measurements.

For example, the temperature profile parameter and other parameter profiles along the fiber can be monitored. The resulting distributed measurement is equivalent to deploying a plurality of conventional point sensors, which would require more equipment and increase operational costs. Each conventional electrical point sensor would require multiple electrical leads and this would add to a large and expensive cable bundle as the number of point sensors increase.

When an optical fiber is excited with a laser light having a center wavelength λ, most of the light is transmitted. However, small portions of incident light λ and other excited components are scattered backward and forward along the fiber. The amplitude of the other excited components depends on the intensity of the light at center wavelength λ and the properties of the optical fiber. In the measurement of distributed temperature using Raman scattering, three components are of particular interest. The three components are Rayleigh back-scattered light, which will have a similar wavelength λ as the original laser wavelength, Raman Stokes and Raman anti-Stokes components which have longer and shorter wavelengths than the original wavelength λ. These three components can be separated by optical filters and received by photo detectors to convert light to electrical signals. A ratio between the temperature sensitive Raman anti-Stokes intensity to the temperature insensitive Rayleigh or largely temperature insensitive Raman Stokes intensity forms the basis of a Raman based distributed temperature measurement.

One problem with current systems and techniques is the ability to measure these parameter profiles over an extended distance, where the optical signal tends to degrade due to the attenuation along the fiber. In conventional fiber optic Raman based DTS systems, as an example, when the intensity of the input light is increased, the Raman Stokes and Raman anti-Stokes respective power in the optical fiber increases as well. This phenomenon is called Spontaneous Raman Scattering. When the input power of the optical source is further increased above a threshold level, stimulated scattering may occur either due to Brillouin scattering or Raman scattering. Stimulated Brillouin scattering manifests itself through the generation of a backward propagating Brillouin Stokes wave that carries most of the input energy once the Brillouin threshold is reached. The threshold level depends on light source properties such as peak power and spectral width, and optical fiber properties such as chemical composition of the fiber, Numerical Aperture and mode field diameter. Once the Brillouin threshold is reached, increased backward propagating non-linear stimulated Brillouin Stokes light may saturate the detector while limiting the amplitude of the forward propagating light. For these reasons, increasing the light energy by increasing the laser power is not a viable approach to increasing the distance reach for a conventional DTS system as the increase in signal energy is back scattered. Stimulated Brillouin scattering is often what limits the maximum power that can be transmitted into optical fibers using narrow line-width high power lasers.

Similarly, stimulated Raman scattering transfers energy in a non-linear fashion from the center light wavelength λ to the Raman Stokes component. As a result, the ratio between Raman Stokes and Raman anti-Stokes varies without temperature changes, thus generating errors in temperature calculations. Data taken in the fiber length where non-linear stimulated interactions occur tends to generate significant errors in temperature calculations.

Other attempts to solve this problem rely on the use of special filters in the fiber line to remove stokes components. Due to the sensitivities of Raman DTS to changes in power levels this approach tends to introduce inaccuracies into the temperature calculation. There have also been attempts to use stimulation to create a main pulse that extends further out into the fiber in single laser STS but these solutions do not work close to the beginning of the fiber and have the problem of not having a reference temperature to tie the trace to. This also makes calibration very difficult.

Hartog et al disclosed a scheme (U.S. Pat. No. 7,304,725) based on a sensing system composed of two sequential physically different fibers with different Numerical Apertures to avoid this effect. They also disclosed another system, in which an optical amplifier (more precisely a length of rare-earth doped fiber in a section of the sensing fiber) was placed in between two sensing fibers to boost up the attenuated input optic energy to reach further distance.

Such approaches introduce cost and complexity in both design and operation. Accordingly, systems and methods that provide for extending the range of fiber optic DTS systems without undue complexity in the sensing fiber design and deployment are desired. Methods that suppress the Stokes wave build-up rather than actively filtering the Stokes wave as it builds up would be preferable.

### BRIEF SUMMARY OF THE INVENTIVE CONCEPT

The need is met with the inventive step described herein. The concept is to use a seed laser pulse in conjunction with the pump (primary) laser pulse and to pulse them simultaneously into a fiber optic distributed temperature sensing system with the laser sources chosen with certain specific frequency difference characteristics.

The need is further met by an apparatus for use in a fiber optic distributed temperature sensing (DTS) system for suppressing stimulated Raman scattering in fiber optic cables including at least a primary pump laser source adapted to pulse a primary light signal for distributed temperature system measurements; a secondary seed laser source adapted to pulse a secondary light signal; and a wavelength division multiplexer (WDM) adapted to receive the primary light signal and the secondary light signal and further adapted to pass the resulting signal into a distributed temperature sensing system.

The need is also met by a method for suppressing stimulated Raman scattering in fiber optic cables in a distributed temperature sensing (DTS) system including at least the steps of feeding a primary pump laser source for a distributed temperature sensing system through a lead fiber and into a wavelength division multiplexer (WDM); feeding a secondary seed laser source through a lead fiber and into the wavelength division multiplexer; and feeding the resultant light from the wavelength division multiplexer into a fiber optic distributed temperature sensing system.

In another aspect the primary pump laser source has approximately a 26 THz higher frequency than the secondary seed laser source.

### BRIEF DESCRIPTION OF THE DRAWINGS

FIG. 1 is a block diagram of one example of a distributed temperature sensing system.

FIG. 2 exhibits some of the typical spontaneous backscattered Raman signals received from a distributed temperature sensing system.

FIG. 3 is a block diagram of a system of this application configured to create suppression of stimulated Raman signals.

FIG. 4 is a graphical diagram showing a mathematical simulation of the pump and stokes power from launching a single high power pump pulse.

FIG. 5 is a bar graph representation of the power profiles from FIG. 4 for initial launch and then the later beam profile much further out in the fiber.

FIG. 6 is a graphical diagram showing a mathematical simulation of the pump and stokes power from launching a dual high power pump pulses.

FIG. 7 is a bar graph representation of the power profiles from FIG. 6 for initial launches and then the later beam profile much further out in the fiber.

### DETAILED DESCRIPTION OF THE INVENTION

In the following detailed description, reference is made accompanying drawings that illustrate embodiments of the present invention. These embodiments are described in sufficient detail to enable a person of ordinary skill in the art to practice the invention without undue experimentation. It should be understood, however, that the embodiments and examples described herein are given by way of illustration only, and not by way of limitation. Various substitutions, modifications, additions, and rearrangements may be made without departing from the spirit of the present invention. Therefore, the description that follows is not to be taken in a limited sense, and the scope of the present invention is defined only by the appended claims.

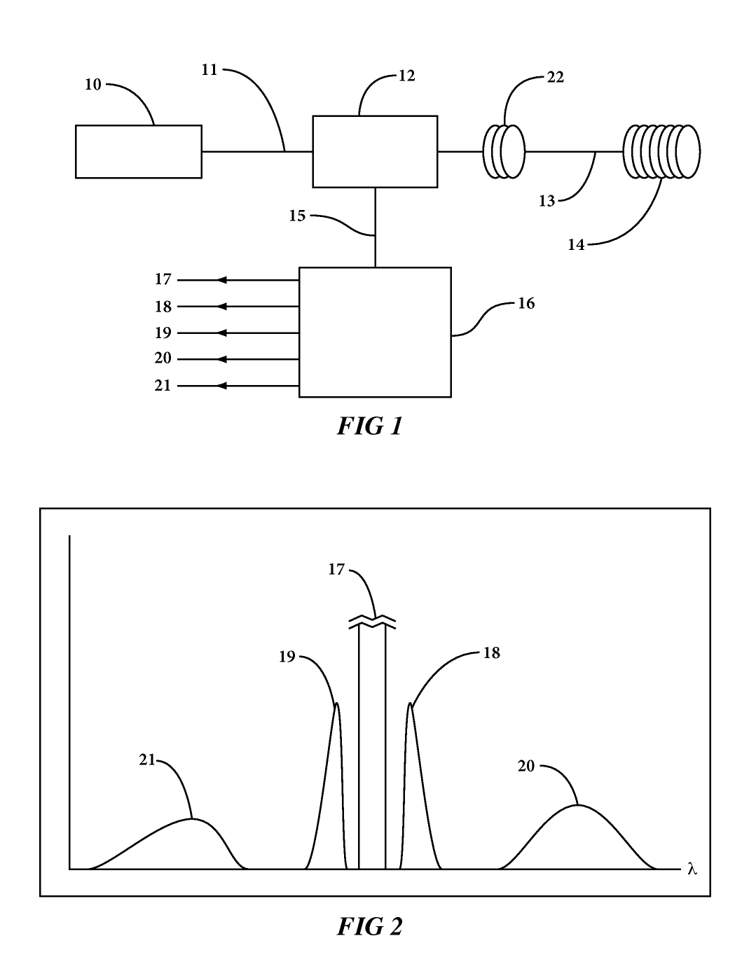

FIG. 1 illustrates a conventional DTS system, including a light source 10, a lead light fiber 11, a light splitter and combiner 12, lead fiber 13, a sensing fiber 14, optical spectrum separator 16, and a reference fiber coil 22. Light source 10 provides optical signal through lead fiber 11 which may reach sensing fiber 14 via light splitter/combiner 12, reference fiber coil 22, and lead fiber 13. During the transmission of optical signal to sensing fiber 14, a portion of the light may be scattered and may travel back to optical spectrum separator 16 via lead fiber 13, light splitter/combiner 12, and lead fiber 15. The backscattered light from the sensing fiber may include light components such as Rayleigh component 17 (same center wavelength as injected light), Brillouin Stokes component 18 and Brillouin Anti-Stokes component 19, Raman Stokes component 20, and Raman Anti-Stokes component 21, all of which may be separated via optical spectrum separator 16. Raman Stokes 20 and Raman anti-Stokes 21 (collected Raman scatterings) may be shifted from the input wavelength of the optical signal and be mirror imaged about Rayleigh component 17, as shown in FIG. 2.

Reference fiber coil 22 of the DTS system may be used as a reference profile for the entire temperature profile of the sensing fiber. For other profiles, reference fiber coil 22 may be used as a reference point to compare or analyze measured points.

In one embodiment, the Raman components may be used to determine parameter profiles such as temperature profiles. The Raman Stokes and Raman Anti-Stokes band are typically separated by more than tens of nanometers, whereas Brillouin components 18 and 19 are much closer—less than 0.1 nanometer from the Rayleigh bandwidth, as shown in FIG. 2. In particular, the temperature may be inversely proportional to the intensity of Raman Stokes component 20 over the intensity of Raman Anti-Stokes component 21.

Due to the nature of the optical sensing fiber, the transmitted light energy is decreased (or attenuated) as it travels through the fiber. As a result, the signal to noise ratio is lowered, which may cause a degradation of the temperature resolution towards the far end of the fiber. One way to solve this problem is to launch higher power laser light to increase the optical energy. However, as discussed earlier, this generates stimulated scattering and induces non-linearity, which degrades the accuracy and/or resolution of the DTS system.

In an aspect of this invention a second seed laser pulse at a second Raman frequency (26 THz shift) can be propagated along with the main pulse. In this aspect as the Stokes wave at 13 THz shift begins to grow, the light is re-stimulated to the next Raman band at the seed wavelength. In this way the Stokes wave is never allowed to fully form ands so stimulation from the main pulse is suppressed.

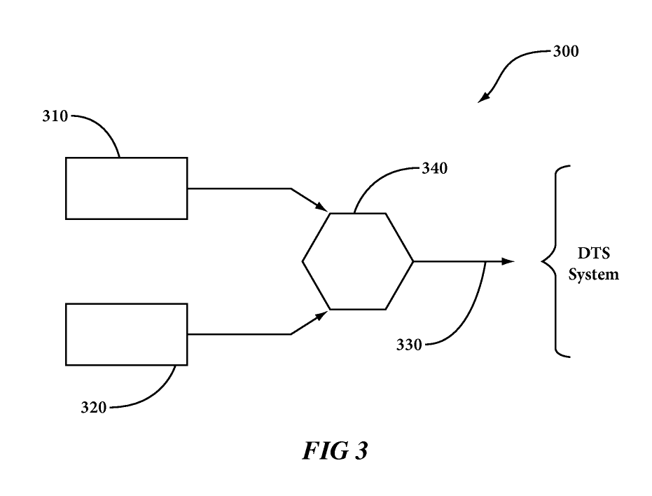

A simple configuration to carry out the invention is illustrated in FIG. 3, illustrated by the numeral 300, in which a primary light source 310 (for example a 1064 nm wavelength pulsed laser) is combined with a seed light source 320 (for example an 1170 nm wavelength pulsed laser) and fed through a lead fiber 330 into a wavelength division multiplexer (WDM) 340 where the two pulses are combined and then fed into a DTS system. A number of different DTS system configurations could be used—the example one in FIG. 1 is one example. Using that as an example source 10 in FIG. 1 would be replaced with configuration 300 of FIG. 3. The two pulsed lasers would be fired simultaneously so that their signals overlap and travel through WDM 340 and into the remainder of the DTS system together.

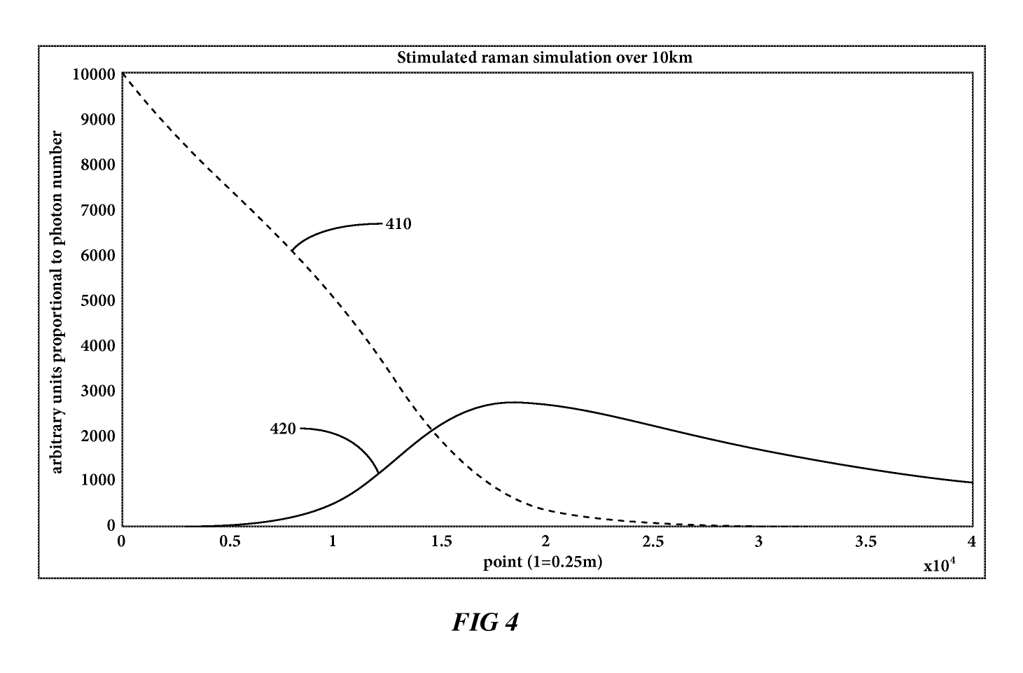

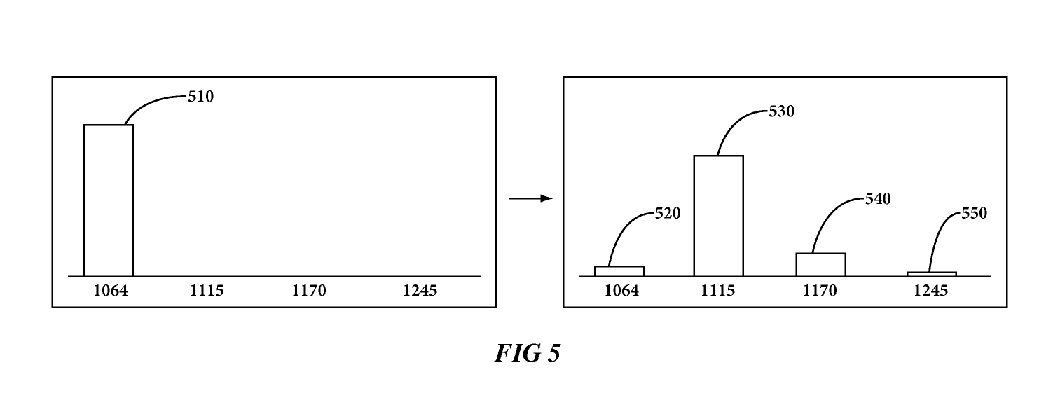

As mentioned previously, when a single laser power is increased to measure over longer distances a regime of stimulated Raman scattering is encountered which introduces non-linearity. It is useful to first show how this occurs when only the pump laser is used at high power to cover a large distance. FIG. 4 is a mathematical simulation of how the laser powers change over a distance of 10 km with a single pump power at 1064 nanometers wavelength is used. The curve 410 represents the relative power of the 1064 nm pulse wave as it travels down the fiber and shows the depletion of that wave as the Stokes wave 420 rapidly grows from the stimulated scattering.

FIG. 5 exhibits this phenomena in a bar graph form in which the initial beam profile, which is all pump pulse 510 at 1064 nm is shown on the left hand side of the graph. Much further out a late beam profile is shown in which the initial 1064 nm wavelength pulse 520 is now severely attenuated as it's energy is transferred into the stimulated Stokes signal 530 at 1115 nm. The non-linear and large Stokes signal 530 is strong enough that it generates it's own further Stokes signal 540 at 1170. A further very small Stokes signal 550 is generated at 1245 nm. These secondary Stokes signals are too small to be clearly seen on FIG. 4. As a result of the large Stokes component 530 at 1115 nm, the ratio between Raman Stokes and Raman anti-Stokes varies without temperature changes, thus generating errors in temperature calculations. Data taken in the fiber length where non-linear stimulated interactions occur can generate significant errors in temperature calculations.

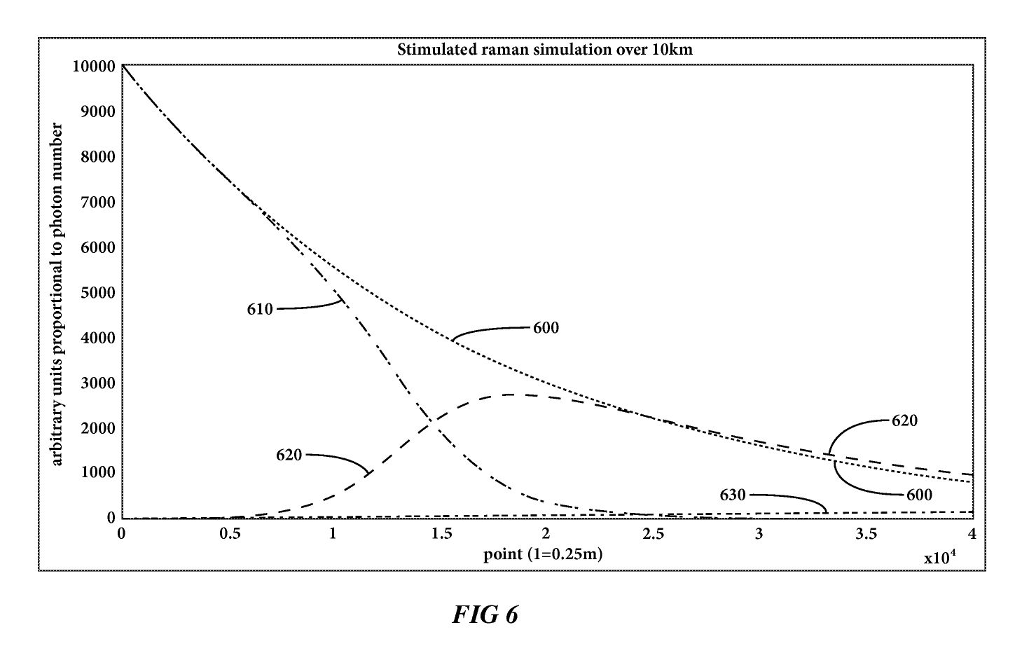

FIG. 6 is an alternate mathematical simulation in which both of the lasers shown in FIG. 3 are fired simultaneously. The two wavelengths of 1064 nm and 1170 nm represent a Raman frequency shift of approximately twice the Raman frequency shift of 13 THz. They are fired in this simulation at identical power. With this combination the seed pulse 610 at 1170 nm generates a stimulated seed Stokes 620 at 1245 nm but in doing so suppresses the stimulated Raman scattering of the pump pulse 600 with the result that the pump stokes 630 at 1115 nm grows in the normal simultaneous manner. As that pump Stokes 630 begins to grow, the light is re-stimulated to the next Raman band at the seed wavelength of 1170 nm.

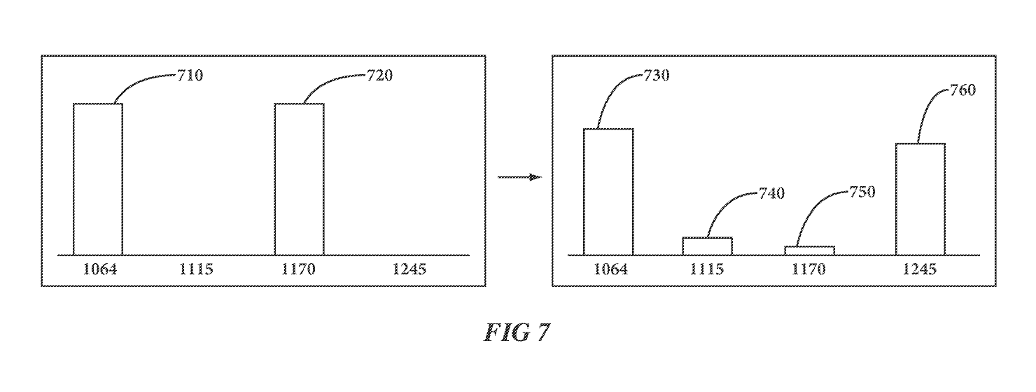

This is illustrated further in FIG. 7 in which the phenomena are illustrated in a bar graph similar to the previous bar graph of FIG. 5. The initial beam profile on the left hand side shows the two identical power lasers—the pump pulse 710 at 1064 nm and the seed pulse 720 at 1115 nm. In the late beam profile it can be seen that unlike FIG. 5 in which the pump pulse is severely depleted—in FIG. 7 the pump pulse 730 at 1064 nm is still substantial because stimulated Raman scattering of the pump pulse has been suppressed and the pump stokes 740 at 1115 nm is now a normal signal that can be used in conjunction with the anti-Stokes signal (not shown) in performing distributed temperature sensing calculations to much greater distances. The seed pulse 750 introduced in the initial profile at 1115 nm though has now experienced stimulated Raman scattering as evidenced in the severely depleted 1170 nm signal accompanied by an enlarged 1245 nm signal 760 that is the seed Stokes signal. This seed Stokes signal is enlarged and non-linear in response but is ignored and not used in any of the DTS calculations. The net effect is the desired suppression of stimulated Raman scattering of the pump pulse.

By the use of this method and apparatus the upper power ceilings can be increased by an order of magnitude providing unmatched range and resolution for long distance measurement of temperatures in DTS systems.

Although certain embodiments of the present invention and their advantages have been described herein in detail, it should be understood that various changes, substitutions and alterations can be made without departing from the spirit and scope of the invention as defined by the appended claims. Moreover, the scope of the present invention is not intended to be limited to the particular embodiments of the processes, machines, manufactures, means, methods and steps described herein. As a person of ordinary skill in the art will readily appreciate from this disclosure, other processes, machines, manufactures, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufactures, means, methods or steps.

1. An apparatus for use in a fiber optic distributed temperature sensing (DTS) system for suppressing stimulated Raman scattering in fiber optic cables comprising:
a. a primary pump laser source adapted to pulse a primary light signal for distributed temperature system measurements;
b. a secondary seed laser source adapted to pulse a secondary light signal; and
c. a wavelength division multiplexer (WDM) adapted to receive said primary light signal and said secondary light signal and further adapted to pass the resulting signal into a distributed temperature sensing system.

2. The apparatus of claim 1 wherein said primary pump laser source has approximately a 26 THz higher frequency than said secondary seed laser source.

3. The apparatus of claim 1 wherein said primary pump and said secondary seed laser sources deliver approximately the same power level.

4. The apparatus of claim 1 wherein said primary pump laser source is a 1064 nanometer laser.

5. The apparatus of claim 1 wherein said secondary seed laser light source is a 1170 nanometer laser.

6. A method for suppressing stimulated Raman scattering in fiber optic cables in a distributed temperature sensing (DTS) system comprising the steps of:
a. feeding a primary pump laser source for a distributed temperature sensing system through a lead fiber and into a wavelength division multiplexer (WDM);
b. feeding a secondary seed laser source through a lead fiber and into said wavelength division multiplexer; and
c. feeding the resultant light from the wavelength division multiplexer into a fiber optic distributed temperature sensing system.

7. The method for suppressing stimulated Raman scattering in fiber optic cables in a distributed temperature sensing (DTS) system of claim 6 wherein said primary pump laser source has approximately a 26 THz higher frequency than said secondary seed laser source.

8. The method for suppressing stimulated Raman scattering in fiber optic cables in a distributed temperature sensing (DTS) system of claim 6 wherein said primary pump and said secondary seed laser sources deliver approximately the same power level.

9. The method for suppressing stimulated Raman scattering in fiber optic cables in a distributed temperature sensing (DTS) system of claim 6 wherein said primary pump laser source is a 1064 nanometer laser.

10. The method for suppressing stimulated Raman scattering in fiber optic cables in a distributed temperature sensing (DTS) system of claim 6 wherein said secondary seed laser source is a 1170 nanometer laser.
